(19) United States
(12) Patent Application Publication
(10) Pub. No.: US 2004/0088535 A1
(43) Pub. Date: May 6, 2004

(54) Method, apparatus and computer program product for selecting computer system settings for various operating circumstances

(75) Inventors: Jeffrey Allen Jones, Round Rock, TX (US); Michael Aaron Kaply, Austin, TX (US)

Correspondence Address: Marilyn S. Dawkins, International Business Machines Corporation, Intel. Prop. Law Dept., Internal Zip 4054, 11400 Burnet Road, Austin, TX, 78758, US

(73) Assignee: International Business Machines Corporation, Armonk, NY

(21) Appl. No.: 10/286,002

(22) Filed: Oct. 31, 2002

(51) Int. Cl. G06F 15/177

(52) U.S. Cl. 713/100

(57) ABSTRACT

According to an apparatus form of the invention, a computer system has a memory for storing settings for respective operating circumstances of the computer system, and a manually operable, externally accessible switch for indicating, by a position of the switch, at least one of the operating circumstances. The computer system further includes means for determining the switch position responsive to the computer system booting and means for selecting among the settings responsive to the switch position. In another aspect, the operating circumstances include locations for operating the computer system. Alternatively, the operating circumstances include users who operate the computer system.

### BACKGROUND

1. Field of the Invention

This invention concerns computer systems, and in particular to computer systems having convenient means for configuring.

2. Related Art

It is well known to configure and reconfigure computer systems for use by different users or for communication with different computer systems, networks or peripheral devices. For example, Garner et al. disclose means for reconfiguring in U.S. Pat. No. 5,014,193, “Dynamically Configurable Portable Computer System,” May 7, 1991. They describe a prior art arrangement in which a portable computer user manually reconfigures a system each time an environment of peripheral devices is encountered by setting switches or jumpers to indicate the presence or absence of external disk drives, designated identities of the drives, whether a particular communication port is connected to a modem, serial printer, etc. This arrangement is clearly not “user friendly.” Jumpers are tedious to remove and install for a number of reasons. They tend to be small. Since they are small and removable they tend to get lost. There tends to be nothing simple or intuitive about their placement.

The sort of switches commonly used as an alternative to jumpers are dual in-line package (“DIP”) switches. DIP switches are similar to jumpers and a little easier to use. Also, since they are attached they don't tend to get lost. But they too have disadvantages. Like jumpers, they are small and their settings are not simple and intuitive. That is, both jumpers and DIP switches have a multiplicity of arcane placements or settings to choose among. For example, placement or setting of four jumpers or DIP switch positions may be required with reference to a table in order to select among eight configurable features. Also, due to their size jumpers and DIP switches tend to require fine motor skills to place or set. This is further agravated by the fact that both jumpers and DIP switches are generally mounted on circuit boards, and consequently are located in rather deep recesses under protective covers, which makes them hard to access.

In another well known means for reconfiguring a system for different users, a system runs software which graphically displays a number of configuration choices for the user to select. A set of the selections is then associated with a user identifier (“ID”) and password and stored in a non-volatile memory of the system. Thereafter, upon booting in connection with powering up the system, or upon rebooting in response to a user logging off, the system software automatically generates a message on a display prompting the user to log on, and then waits for the user to manually key in the ID and password. While in some respects it is an improvement to have stored configurations and a software-guided arrangement for logging on and reconfiguring, nevertheless, it can be a nuisance for the user to have to remember a user ID and password, and it causes at least a small delay for the system to wait for the user to enter the information, even if the system is booting anyway in connection with powering up.

As the foregoing indicates, a need exists for improvements in configuring and reconfiguring computer systems.

### SUMMARY

The foregoing need is addressed in the present invention. According to an apparatus form of the invention, a computer system has a memory for storing settings for respective operating circumstances of the computer system, and a manually operable, externally accessible switch for indicating, by a position of the switch, at least one of the operating circumstances. The computer system further includes means for determining the switch position responsive to the computer system booting and means for selecting among the settings responsive to the switch position.

In another aspect, the operating circumstances include locations for operating the computer system. Alternatively, the operating circumstances include users who operate the computer system.

The settings define what may commonly be referred to as structure, characteristics, preferences, parameters, configurations, or content (collectively referred to herein as “configurations” or “characteristics”) for numerous configurable features of the computer system. Settings define, for example, characteristics of an Internet browser, a desktop projected on a display of the computer system, communication between the computer system and a network, etc.

The switch is advantageous not only because it has a mechanism such as a handle or button or the like protruding from the computer system case, making it externally accessible without removing a cover, but also because a single position of the switch sets numerous configurable features. The switch may have several easily selectable positions, but each position corresponds to an entire user-determined configuration that includes a set of a number of configurable features. Additional aspects and other objects, advantages and forms of the invention will become apparent upon reading the following detailed description and upon reference to the accompanying drawings.

### BRIEF DESCRIPTION OF THE DRAWINGS

FIG. 1 illustrates aspects of a computer system in a block diagram form, according to an embodiment of the present invention.

FIG. 2 illustrates details for a lookup table, according to an embodiment.

FIG. 3 illustrates details for one set of settings, according to an embodiment.

FIG. 4 illustrates an algorithm for certain aspects of the computer system operation, according to an embodiment.

FIGS. 5A through 5D illustrates embodiments for the switch of FIG. 1.

FIGS. 6A and 6B illustrate aspects of structure and functioning of an interlock arrangement, in which the computer system case is inserted and removed from a docking station, according to an embodiment.

FIG. 7 illustrates further details of the computer system of FIG. 1, according to an embodiment.

### DETAILED DESCRIPTION OF A PREFERRED EMBODIMENT

The claims at the end of this application set out novel features which applicants believe are characteristic of the invention. The invention, a preferred mode of use, further objectives and advantages, will best be understood by reference to the following detailed description of an illustrative embodiment read in conjunction with the accompanying drawings.

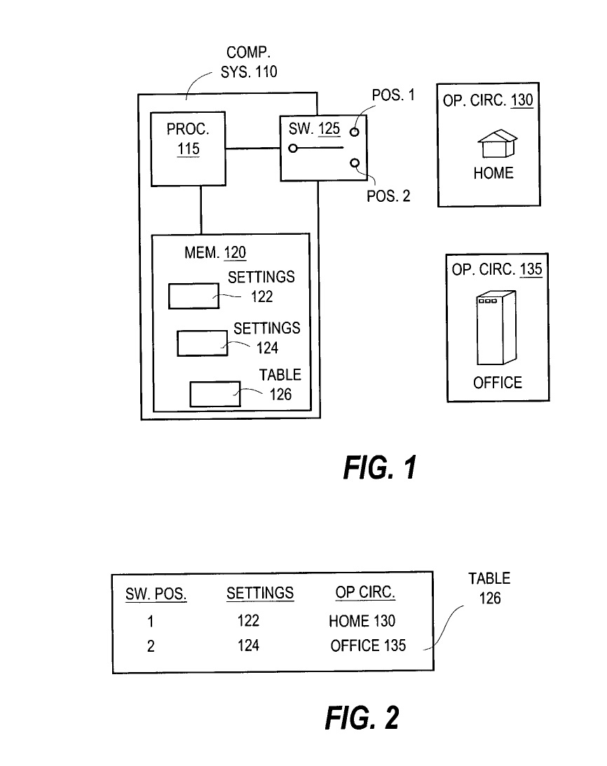

Referring now to FIG. 1, computer system 110 is shown, according to an embodiment. The computer system 110 has a processor 115 communicatively coupled to a switch 125 and a memory 120. The switch 125 is easily accessible by a user, so that the user can operate the switch 125 to place it in either position 1 or position 2. The first and second positions of the switch 125 correspond to respective operating circumstances 130 and 135 for the system 110. In other embodiments, the switch 125 is of a type that has more than two positions so that several operating circumstances can be selected. In the embodiment illustrated in FIG. 1, operating circumstance 130 is for operating at the system 110 user's home, whereas operating circumstance 135 is for operating at the system 110 user's office. In other embodiments, the operating circumstances may relate to other circumstances besides physical locations. In one embodiment the circumstances correspond to users. For example, for a computer system 110 that is shared by members of a family, there is an “operating circumstance” for each spouse and each child in the family.

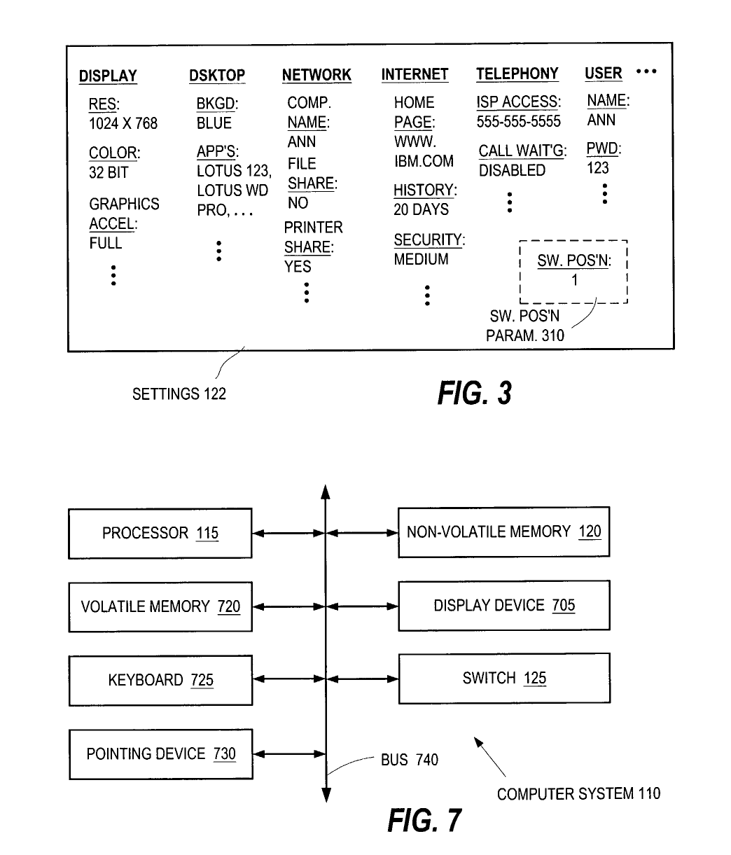

The memory 120 is for storing program instructions for the processor 115 and also for 20 storing settings, such as settings 122 and 124, as shown. The settings 122 and 124 correspond to respective operating circumstances 130 and 135 for the system 110. To further illustrate the nature and purpose of settings, an embodiment of settings 122 is shown in more detail in FIG. 3. Before referring to FIG. 3, however, consider lookup table 126, which is also stored in memory 120.

Referring now to FIG. 2, details are shown for lookup table 126, according to an embodiment. The lookup table 126 provides a convenient means for cross-referencing switch 125 (FIG. 1) positions to settings, each of which correspond to respective operating circumstances. That is, the first row of the table 126 lists switch 125 position 1, settings 122 and home operating circumstance 130, thereby associating these three items with one another. Likewise, the second row associates switch 125 position 2, settings 124 and office operating circumstance 135. Thus, processor 115 ( FIG. 1) can read the switch 125 position and then use lookup table 126 to lookup settings that correspond to the position.

It should be appreciated that in comparison to a user manually looking up jumper or DIP switch settings in a table it is much more convenient for the user to use a graphical user interface to initially select and save a set of settings 122, etc. for a number of configureable features associated with one simple switch 125 position, so that the computer automatically creates the lookup table 126 which the processor 115 can then automatically refer to later in order to retrieve the settings 122 responsive to a single position of the switch 125.

Referring now to FIG. 3, details are illustrated for one set of the settings 122, according to an embodiment. Selections defining, characteristics for numerous configurable features of computer system 110 are stored in settings 122. The selections may be affirmatively made by the user, or they may be default selections, such as may be made for the user by the computer system 110 integrator, hardware provider or software provider, for example. Settings 122 include selections for the system 110 “desktop,” a collection of program icons, buttons, task bars, and other information projected onto a display of the system 110 to assist the user in system operation. Settings 122 also include selections for the system 110 display itself, networks to which the system 110 may be connected, Internet preferences, telephony parameters, and user identification, as illustrated. These are just a few of many configurable selections for well known computer systems, as is understood by persons of ordinary skill in the areas of computer system hardware and software. These many configurable selections may be included in settings 122. It should be understood that these settings may be stored in one or more files in memory 120 (FIG. 1), including a “config.sys file,” for example.

To more clearly illustrate the nature of these selections included in the settings 122, FIG. 3 sets out merely a few exemplary selections. In particular, for the computer system 110 display, a selection of “1024×768” is shown for the display resolution, a selection of “32 bit” is shown for the display color, and it is shown that full graphics acceleration has been selected. For the desktop, a blue background has been selected, and applications selected to have icons on the desktop include Lotus 123 and Lotus WordPro. (Both “Lotus 123” and “Lotus WordPro” are trademarks of the IBM Corporation.) For network communication, “Ann” has been selected as the computer system 110 name, file sharing has been set to “no,” and printer sharing has been set to “yes.” For Internet preferences, the home page has been set to “www.ibm.com,” the number of days for saving history has been set to 20, and security has been set to medium. For telephony, an Internet service provider telephone access number has been set to “555-555-5555,” and call waiting has been set to “disable.” For user identification, the user name has been set to “Ann,” and the password has been set to “123.”

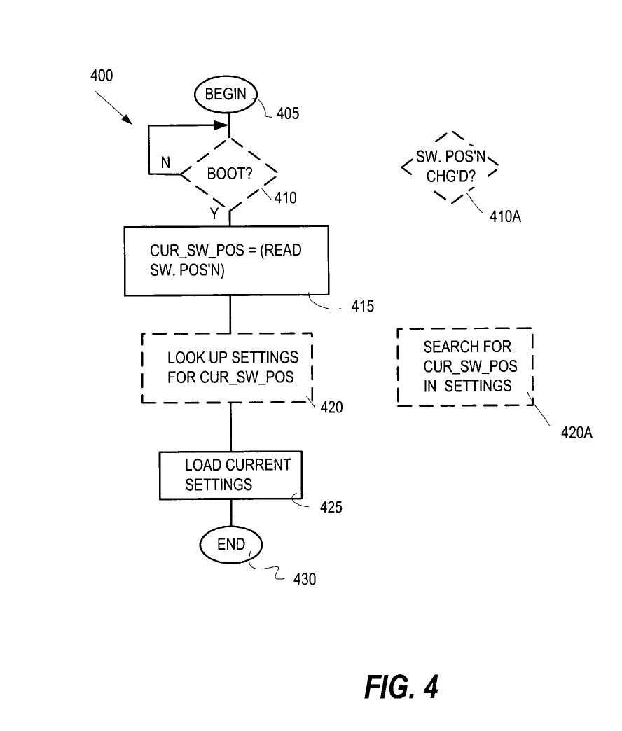

Referring now to FIG. 4, an algorithm 400 is shown for certain aspects of operation of the computer system 110, according to an embodiment. After beginning at 405, the algorithm monitors for booting of the system 110. If booting is detected at 410, then at 415 the position of switch 125 is read and a variable “CUR_SW_POS” for the current switch position is set to a value corresponding to the position that was read. (Note that in addition, or as an alternative, in block 410A switch 125 position is monitored for a change. If the position changes, then the algorithm 400 branches to block 415.) Next, at 420, the lookup table 126 is consulted to find which settings 122, 124, etc. correspond to the current switch position. (Note that in an alternative 420A, instead of using a lookup table the algorithm 400 searches for sets of settings 122, 124, etc. that have values for their switch position parameter 310 (FIG. 3) corresponding to the current switch position.) Then, at 425, those settings are automatically loaded into processor 115 (FIG. 1), and the system 110 is accordingly configured for those settings, and the algorithm ends at 430.

Note that, advantageously, no user intervention is required at boot time, especially for the block 410 alternative. Moreover, at the time the system is turned off the user may well have a good idea where the system will next be used, and by whom. Thus, the user may conveniently put the switch 125 in a position reflecting the next intended use when the system is turned off, for example, at the end of a day at work. Then, when the system 110 is next turned on, perhaps at home in the evening, no further user intervention is required to obtain the desired settings for the operating circumstance. Note also that since the switch may thus be already set in the desired position at boot time, the operating system can cause the processor to query the switch and determine its position early in booting, and then cause the processor to immediately look up and automatically load the settings for the current switch position, so user intervention is not only reduced or eliminated at boot time, but the boot up interval is also reduced. Contrast this to one convention alternative, wherein the system halts during booting, the user is prompted to log on by a message on the system display, and the system waits until the user responds.

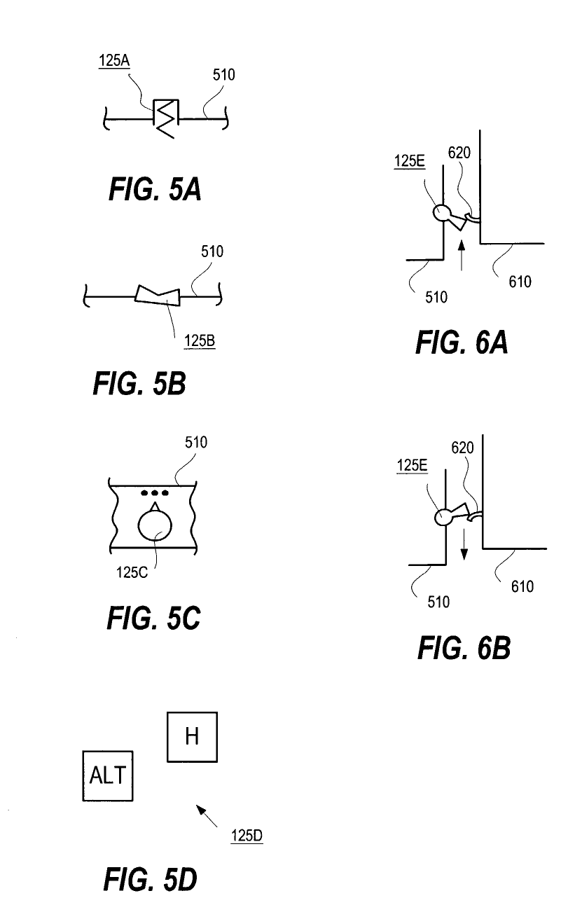

Referring now to FIG. 5A, an embodiment for the switch 125 of FIG. 1 is illustrated. In this embodiment, a spring loaded pushbutton switch 125A is provided. The switch 125A has an external button that protrudes somewhat from an external case 510 for the computer system 110. Pushing in the button on the switch 125A a first time causes it to lock in a first, retracted position, and pushing in the switch 125A button a second time causes it to lock in a second, extended position. Pushing it in a third time returns the switch 125A to the first position, pushing it in a fourth time returns the switch 125A to the second position, and so on.

Referring now to FIG. 5B, another embodiment for the switch 125 of FIG. 1 is illustrated. In this embodiment, a rocker switch 125B (sometimes also referred to as a type of toggle switch) is provided. The rocker switch 125B has two positions, depending on which end of the rocker is depressed. The rocker portion of the switch 125B protrudes somewhat from the case 510 for easy access.

Referring now to FIG. 5C, another embodiment for the switch 125 of FIG. 1 is illustrated. In this embodiment, a selector switch 125C is provided, which has click stops for holding the switch 125C in one of a number of positions that are selected by turning the switch 125C. The switch 125C has a dial that protrudes from the case 510 for easy access.

Referring now to FIG. 5D, another embodiment for the switch 125 of FIG. 1 is illustrated. In this embodiment, a combination of keys on a keyboard of the computer system 110 are simultaneously depressed to set a first switch position. In the illustration, the “ALT” key and the “H” key are pressed together to set a first switch position for a home operating circumstance. Another switch position can be set by another combination of keys. For example, in one embodiment the “ALT” key and the “O” key are pressed together to set a second switch position indicating an office operating circumstance.

Referring now to FIG. 6A, an arrangement is shown in which the computer system 110 (FIG. 1) case 510 is inserted in a docking station 610. The docking station has a flexible finger 620 which engages a two position toggle switch 125E when the computer case 510 is inserted in the docking station 610, and moves the switch 125E to a first position. In other words, the switch 125E is located on the case 510 in such a way as to be interlocked with the docking station 610 via the finger 620. If the docking station 610 is at work, for example, settings for the switch 125E first position can be pre-configured for the work operating circumstance, so that inserting the case 510 automatically moves the switch 125E to the position that causes the system 110 to boot up in the work operating circumstance configuration on the next system 110 boot.

Referring now to FIG. 6B, the computer system 110 (FIG. 1) case 510 is shown being removed from the docking station 610. The docking station flexible finger 620 again engages the two position toggle switch 125E, this time moving the switch 125E to a second position, opposing the first position. Again, if the docking station 610 is at work, the user can pre-configure settings for the switch 125E second position for the home operating circumstance, so that removing the case 510 automatically moves the switch 125E to the position that causes the system 110 to automatically boot up in the home operating circumstance configuration on the next system 110 boot.

Note that in all the arrangements illustrated herein above, the switches 125A, etc. are easily accessible to the user. That is, the switches have a manually operable element, such as a handle, in a exposed location on a surface of the external case 510, e.g., accessible without removing a cover. (In an embodiment such as the one described above using keys on the keyboard, the monitor for the system may need to be flipped open, but aside from that there is no cover on the switch.) This is advantageous in some respects, but in other embodiments the switch may not be quite so extremely easily accessible. For example, in an embodiment the manually operable element of the switch is slightly recessed in the case to prevent the switch position from being inadvertently changed, but the manually operable element is still relatively large, simple to operate and easily acessible. Also, a locking mechanism is included in an embodiment to prevent the switch position from being inadvertently changed.

Referring now to FIG. 7, more details of computer system 110 are shown, according to an embodiment. Computer system 110 has the processor 115, nonvolatile memory 120 (for example, read only memory, hard disk, floppy disk, CD-ROM, etc.), and switch 125 previously described. The system 110 also includes volatile memory 720 (that is, random access memory, for example), and a display unit 705. The memory 120 is for storing programs for controlling the processor 115, and settings, etc. as previously stated. (The same applies to memory 720.) Accordingly, processor 115 is operative with the programs to function as described herein, for example, as described for algorithm 400 (FIG. 4).

In various embodiments the system 110 also has a keyboard 725 and a pointing device 730, such as a mouse, trackball, touch pad, touch sensitive display, etc. The keyboard 725 is a device of the sort that is sometimes referred to as a “data entry” device. In other embodiments, the system 110 includes a data entry device such as a microphone for receiving voice commands, a keypad, buttons etc., and may or may not omit the keyboard 725. These components described in the two preceding paragraphs are interconnected in the system 110 by bus 740.

The invention is particularly well suited for a computer system 110 that is easily moved from location to location, however, the invention is not limited to such a system. In various embodiments computer system 110 takes a variety of forms, including a mainframe, a workstation, a personal computer, a notebook computer, a laptop computer, an Internet appliance, a personal digital assistant (“PDA”), a conventional telephone, a cell phone, an appliance with embedded processor and memory, etc. That is, it should be understood that the term “computer system” is intended to encompass any device having a processor that executes instructions from a memory medium. The memory medium preferably stores instructions (also known as a “software program” or simply “program”) for implementing various embodiments of a method in accordance with the present invention. In various embodiments the one or more software programs are implemented in various ways, including procedure-based techniques, component-based techniques, and/or object-oriented techniques, among others. Specific examples include XML, C++ objects, Java and Microsoft Foundation Classes (MFC).

The description of the present embodiment has been presented for purposes of illustration, but is not intended to be exhaustive or to limit the invention to the form disclosed. Many modifications and variations will be apparent to those of ordinary skill in the art. For example, those of ordinary skill in the art will appreciate that processes of the present invention are capable of being performed by a processor responsive to stored instructions, and accordingly some or all of the processes may be distributed in the form of a computer readable medium of instructions in a variety of forms and that the present invention applies equally regardless of the particular type of signal bearing media actually used to carry out the distribution. Examples of computer readable media include RAM, flash memory, recordable-type media, such a floppy disk, a hard disk drive, a ROM, and CD-ROM, and transmission-type media such as digital and analog communications links, e.g., the Internet.

To reiterate, the embodiments were chosen and described in order to best explain the principles of the invention, the practical application, and to enable others of ordinary skill in the art to understand the invention. Various other embodiments having various modifications may be suited to a particular use contemplated, but may be within the scope of the present invention. Moreover, it should be understood that the actions in the following claims do not necessarily have to be performed in the particular sequence in which they are set out.

What is claimed is:

1. A computer system comprising:
a memory for storing settings for respective operating circumstances of the computer system;
a manually operable, externally accessible switch for indicating, by a position of the switch, at least one of the operating circumstances;
means for determining the switch position responsive to the computer system booting; and
means for selecting among the settings responsive to the switch position.

2. The system of claim 1, wherein the operating circumstances comprise locations for operating the computer system.

3. The system of claim 1, wherein the operating circumstances comprise users who operate the computer system.

4. The system of claim 1, wherein the settings define at least one characteristic of a desktop projected on a display of the computer system.

5. The system of claim 1, wherein the settings define at least one characteristic for communication between the computer system and a network.

6. The system of claim 1, wherein the settings define at least one characteristic for an Internet browser.

7. The system of claim 1, wherein changing the switch position causes the computer system to automatically re-select settings from among the settings during a next boot sequence.

8. The system of claim 1, wherein the switch comprises a button.

9. The system of claim 1, wherein the switch comprises a toggle switch.

10. The system of claim 1, wherein the switch comprises a selector switch.

11. The system of claim 1, wherein the switch comprises a keyboard combination.

12. The system of claim 1, wherein the computer is operable in a docking station and the switch is operable to interlock with the docking station such that the switch is automatically set to a first position responsive to the computer being inserted into the docking station, and a second position responsive to the computer being removed from the docking station.

13. A method in a computer system, the method comprising the steps of:
storing settings in a memory for respective operating circumstances of the computer system;
receiving an indication, by a position of a manually operable, externally accessible switch of the computer system, at least one of the operating circumstances;
determining the switch position responsive to the computer system booting; and
selecting one of the settings responsive to the switch position.

14. The method of claim 13, wherein the operating circumstances comprise locations for operating the computer system.

15. The method of claim 13, wherein the operating circumstances comprise users who operate the computer system.

16. The method of claim 13, wherein the settings define at least one characteristic of a desktop projected on a display of the computer system.

17. The method of claim 13, wherein the settings define at least one characteristic for communication between the computer system and a network.

18. The method of claim 13, wherein the settings define at least one characteristic for an Internet browser.

19. The method of claim 13, comprising the step of:
re-selecting one of the settings automatically during a next boot sequence responsive to a change in the switch position.

20. The method of claim 13, wherein the computer is operable in a docking station and the switch is operable to interlock with the docking station, the method comprising the steps of:
setting the switch automatically to a first position responsive to the computer being inserted into the docking station; and
setting the switch automatically to a second position responsive to the computer being removed from the docking station.

21. A computer program product comprising:
instructions for storing settings in a memory for respective operating circumstances of a computer system;
instructions for receiving an indication, by a position of a manually operable, externally accessible switch of the computer system, at least one of the operating circumstances;
instructions for determining the switch position responsive to the computer system booting; and
instructions for selecting one of the settings responsive to the switch position.

22. The computer program product of claim 21, wherein the operating circumstances comprise locations for operating the computer system.

23. The computer program product of claim 21, wherein the operating circumstances comprise users who operate the computer system.

24. The computer program product of claim 21, wherein the settings define at least one characteristic of a desktop projected on a display of the computer system.

25. The computer program product of claim 21, wherein the settings define at least one characteristic for communication between the computer system and a network.

26. The computer program product of claim 21, wherein the settings define at least one characteristic for an Internet browser.

27. The computer program product of claim 21, comprising:
instructions for re-selecting one of the settings automatically during a next boot sequence responsive to a change in the switch position.
